(19) United States
(12) Patent Application Publication
(10) Pub. No.: US 2025/0291088 A1
(43) Pub. Date: Sep. 18, 2025

(54) DROUGHT IMPACT ASSESSMENT SYSTEM AND METHOD BASED ON TEXT MINING FOR DROUGHT DAMAGE ARTICLES AND ACTUAL DATA

(71) Applicants: JOONGBU UNIVERSITY Foundation of Research & Business, Geumsan-gun (KR); International Center for Urban Water Hydroinformatics Research & Innovation, Incheon (KR)

(72) Inventors: Joo Heon LEE, Yongin-si (KR); Seung Kwon JUNG, Incheon (KR); Da Som HUR, Incheon-si (KR); Hyeon Cheol YOON, Busan (KR)

(73) Assignees: JOONGBU UNIVERSITY Foundation of Research & Business, Geumsan-gun (KR); International Center for Urban Water Hydroinformatics Research & Innovation, Incheon (KR)

(21) Appl. No.: 19/079,063

(22) Filed: Mar. 13, 2025

(30) Foreign Application Priority Data
Mar. 18, 2024 (KR) 10-2024-0036865

(51) Int. Cl. G01W 1/10; G01W 1/14; G06F 16/29

(52) U.S. Cl. CPC G01W 1/10; G01W 1/14; G06F 16/29

(57) ABSTRACT

A drought impact assessment system includes a data collection/storage unit configured to construct data by collecting drought damage article data, a standard precipitation index and meteorological drought forecasting/warning data; a meteorological drought impact index assessment unit configured to output a meteorological drought impact index that aggregates occurrence of monthly drought damage; an accuracy verification unit configured to analyze the linear correlation between the meteorological drought impact index and the standard precipitation index, and output a correlation coefficient; an accuracy evaluation unit configured to classify the correlation coefficient and meteorological drought forecasting/warning performance, and calculate a drought index accuracy; and a meteorological drought stage assessment unit configured to assess a drought stage by applying, depending on the drought index accuracy, drought classification according to a drought impact index, drought classification according to a standard precipitation index or drought classification according to a value obtained by correcting a standard precipitation index.

### BACKGROUND

### 1. Technical Field

The present disclosure relates to a drought impact assessment system and method, and more particularly, to a system and method for assessing a drought impact on the basis of text mining for drought damage articles and actual data.

### 2. Related Art

Due to climate change, drought damage is increasing every year to the extent that arid areas around the world are increasing by equal to or more than 50%. Even in Korea, since meteorological observations began in 1973, nationwide droughts have been repeated every 5 to 7 years, and since 2008, the frequency of regional droughts has been gradually worsening each year.

Due to the effects of climate change, the frequency and number of droughts are expected to increase in the future, but preemptive drought response is inadequate because there is no drought monitoring and early warning system in place.

In addition, drought-related information is produced by each organization, and there is a lack of connectivity between ministries, so there are limitations in the information provided. Although the government's disaster management policy in the drought field has changed significantly, the scientific and technological capabilities necessary for drought management are still insufficient.

For example, when the Han River Flood Control Office, the Korea Water Resources Corporation and the Korea Rural Community Corporation produce drought information by sector and input data into the National Drought Information Service, the National Disaster Management Research Institute compiles the drought information provided by the respective organizations, reviews the data and compares the drought situations of local governments, and the Ministry of the Interior and Safety announces forecasting/warning at levels such as attention, caution, alert and serious. Among the other ministries, the Ministry of Agriculture, Food and Rural Affairs provides only information on agricultural water, the Ministry of Environment provides only information on household and industrial water, and the Korea Meteorological Administration provides only meteorological information.

### PRIOR ART LITERATURES

### Patent Documents

(Patent Document 1) Korean Patent No. 10-2277676 entitled “One Map System for National Drought Forecasting and Warning”
(Patent Document 2) Korean Patent Application Publication No. 10-2009-0090949 entitled “Optimal Operational Policy System for Drought Management and Method for Applying the Same”
(Patent Document 3) Korean Patent No. 10-1440932 entitled “Method for Management of Real-time Ensemble Drought Outlook Information”

### SUMMARY

An object of the present disclosure is to provide a system and method for assessing a drought impact on the basis of text mining for drought damage articles and actual data that can collect drought damage articles through web crawling, calculate the accuracy between a meteorological drought impact index calculated on the basis of meteorological damage article occurrence history data and a meteorological drought forecasting/warning history, and determine differently a drought stage depending on an accuracy index.

Objects to be achieved by the present disclosure are not limited to the objects mentioned above, and other objects not mentioned above may be clearly understood by those skilled in the art from the following description.

In an embodiment, a drought impact assessment system based on text mining for drought damage articles and actual data may include: a data collection/storage unit configured to construct data by collecting drought damage article data for a predetermined period of time, collecting a standard precipitation index by region from the database of the Korea Meteorological Administration and collecting meteorological drought forecasting/warning data from the database of the Korea Meteorological Administration; a meteorological drought impact index assessment unit configured to output a meteorological drought impact index that aggregates the occurrence of monthly drought damage for the predetermined period of time, using a meteorological damage article occurrence history by month/region outputted from the data collection/storage unit; an accuracy verification unit configured to analyze the linear correlation between the meteorological drought impact index outputted from the meteorological drought impact index assessment unit and the standard precipitation index by region, and output a correlation coefficient; an accuracy evaluation unit configured to classify the correlation coefficient outputted from the accuracy verification unit and meteorological drought forecasting/warning performance into four cases, and calculate a drought index accuracy according to a predetermined drought index accuracy assessment equation for the four cases; and a meteorological drought stage assessment unit configured to assess a drought stage by applying, depending on the drought index accuracy, one of drought classification according to a drought impact index, drought classification according to a standard precipitation index and drought classification according to a value obtained by correcting a standard precipitation index.

According to one aspect of the present disclosure for achieving the objects and other features of the present disclosure, there is provided that the meteorological drought impact index (Art6) satisfies the following equation

$$Art 6 = ( {\sum }_{Δ t = 0}^{5} A r ( t - Δ t ) ) \div 6$$

where Art is a drought impact index that indicates whether a meteorological damage article for a specific region r has occurred in a month t, and has a value of 0 or 1.

According to one aspect of the present disclosure for achieving the objects and other features of the present disclosure, there is provided that the correlation coefficient (rXY) satisfies the following equation

$${r}_{{XY}^{=}} \frac{{\sum }_{i = 1}^{n} ( {X}_{i} - {X}_{mean} ) ( {Y}_{i} - {Y}_{mean} )}{\sqrt{{\sum }_{i = 1}^{n} {( {X}_{i} - {X}_{mean} )}^{2}} \sqrt{{\sum }_{i = 1}^{n} {( {Y}_{i} - {y}_{mean} )}^{2}}}$$

where Xi is a meteorological drought impact index (Art6), Xmean is the mean of meteorological drought impact indexes (Art6), Yi is a standard precipitation index (SPI6) by city, county and district, Ymean is the mean of standard precipitation indexes (SPI6) by city, county and district, and n is the number of data.

According to one aspect of the present disclosure for achieving the objects and other features of the present disclosure, there is provided that the drought index accuracy satisfies the following equation

$$Accuracy = \frac{T P + T N}{T P + F P + F N + T N}$$

where TP is a case where a drought forecasting/warning occurs and a correlation coefficient is positive, FP is a case where a drought forecasting/warning occurs and a correlation coefficient is negative, FN is a case where a drought forecasting/warning does not occur and a correlation coefficient is positive, and TN is a case where a drought forecasting/warning does not occur and a correlation coefficient is negative.

According to one aspect of the present disclosure for achieving the objects and other features of the present disclosure, there is provided that the meteorological drought stage assessment unit performs: a function of determining whether the drought index accuracy is ‘Excellent,’ reading, when the drought index accuracy is ‘Excellent,’ a drought impact index assessed by the meteorological drought impact index assessment unit, and determining a meteorological drought classification corresponding to the drought impact index as a current drought stage; a function of determining, when the drought index accuracy is not ‘Excellent,’ whether the drought index accuracy is ‘Fail,’ reading, when the drought index accuracy is ‘Fail,’ a standard precipitation index stored in the data collection/storage unit, and determining a meteorological drought classification corresponding to the standard precipitation index as a current drought stage; and a function of, when the drought index accuracy is not ‘Excellent’ or ‘Fail,’ calculating a corrected standard precipitation index (SPI6-C) by multiplying the standard precipitation index (SPI6) and a median value (SPI6_Art6) of a standard precipitation index range corresponding to the drought impact index (Art6) at a predetermined ratio, and determining a meteorological drought classification corresponding to the corrected standard precipitation index (SPI6-C) as a current drought stage.

In an embodiment, a drought impact assessment method based on text mining for drought damage articles and actual data may include: a data collection/storage act of constructing data in a data collection/storage unit by collecting drought damage article data for a predetermined period of time, collecting a standard precipitation index by region from the database of the Korea Meteorological Administration and collecting meteorological drought forecasting/warning data from the database of the Korea Meteorological Administration; a meteorological drought impact index assessment act of outputting a meteorological drought impact index that aggregates the occurrence of monthly drought damage for the predetermined period of time, using a meteorological damage article occurrence history by month/region outputted from the data collection/storage act; an accuracy verification act of analyzing the linear correlation between the meteorological drought impact index outputted from the meteorological drought impact index assessment act and the standard precipitation index by region, and outputting a correlation coefficient; an accuracy evaluation act of classifying the correlation coefficient outputted from the accuracy verification act and meteorological drought forecasting/warning performance into four cases, and calculating a drought index accuracy according to a predetermined drought index accuracy assessment equation for the four cases; and a meteorological drought stage assessment act of assessing a drought stage by applying, depending on the drought index accuracy, one of drought classification according to a drought impact index, drought classification according to a standard precipitation index and drought classification according to a value obtained by correcting a standard precipitation index.

According to one aspect of the present disclosure for achieving the objects and other features of the present disclosure, there is provided that the meteorological drought stage assessment act comprises: an act of determining whether the drought index accuracy is ‘Excellent,’ reading, when the drought index accuracy is ‘Excellent,’ a drought impact index assessed in the meteorological drought impact index assessment act, and determining a meteorological drought classification corresponding to the drought impact index as a current drought stage; an act of determining, when the drought index accuracy is not ‘Excellent,’ whether the drought index accuracy is ‘Fail,’ reading, when the drought index accuracy is ‘Fail,’ a standard precipitation index stored in the data collection/storage unit, and determining a meteorological drought classification corresponding to the standard precipitation index as a current drought stage; and an act of, when the drought index accuracy is not ‘Excellent’ or ‘Fail,’ calculating a corrected standard precipitation index (SPI6-C) by multiplying the standard precipitation index (SPI6) and a median value (SPI6_Art6) of a standard precipitation index range corresponding to the drought impact index (Art6) at a predetermined ratio, and determining a meteorological drought classification corresponding to the corrected standard precipitation index (SPI6-C) as a current drought stage.

According to the system for assessing a drought impact on the basis of text mining for drought damage articles and actual data in accordance with the present disclosure, effects are provided in that it is possible to collect drought damage articles through web crawling, calculate the accuracy between a meteorological drought impact index calculated on the basis of meteorological damage article occurrence history data and a meteorological drought forecasting/warning history, and determine differently a drought stage depending on an accuracy index.

### BRIEF DESCRIPTION OF THE DRAWINGS

FIG. 1 is a block diagram of a drought impact assessment system based on text mining for drought damage articles and actual data according to an embodiment of the present disclosure.

FIG. 2 is a flowchart of a drought impact assessment process according to an embodiment of the present disclosure.

FIG. 3 is a detailed configuration diagram of a data collection unit according to an embodiment of the present disclosure.

FIG. 4 is a flowchart of meteorological drought stage assessment according to an embodiment of the present disclosure.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

Specific embodiments according to the present disclosure will be described below with reference to the accompanying drawings. However, this is not intended to limit the invention to any particular embodiment, and is to be understood to include all modifications, equivalents, and substitutions that fall within the idea and technical scope of the invention.

Throughout the specification, parts having like construction and operation are designated by the same reference signs. In addition, the accompanying drawings of the present disclosure are for the convenience of illustration only, and shapes and relative dimensions thereof may be exaggerated or omitted.

In describing embodiments in detail, redundant descriptions or descriptions of techniques that are obvious in the field are omitted. In addition, whenever any part is the to “include” other components in the following description, it is intended to include components in addition to those listed, unless the contrary is specifically indicated.

In addition, terms such as “part,” “section,” “module,” and the like used herein mean a unit that performs at least one function or operation, which may be implemented in hardware, software, or a combination of hardware and software. Also, when one part is the to be electrically connected to another part, this includes direct connections as well as connections with other configurations in between.

Terms containing ordinal numbers, such as first, second, and the like, may be used to describe various components, but the components are not limited by such terms. These terms are used only to distinguish one component from another. For example, a second component may be named as a first component, and similarly, a first component may be named as a second component, without departing from the scope of the present disclosure.

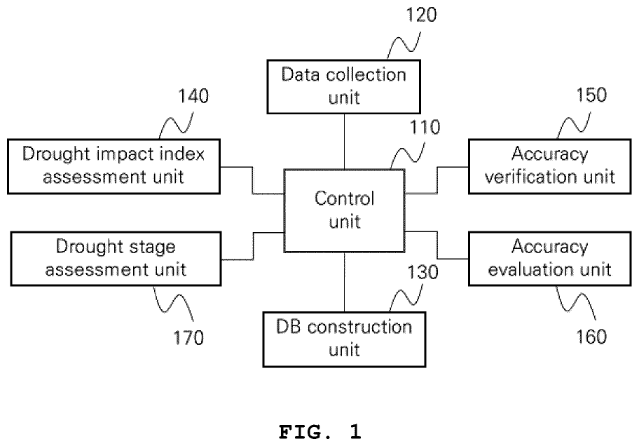

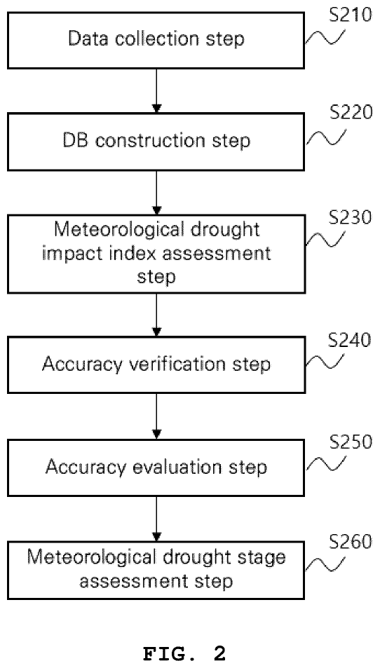

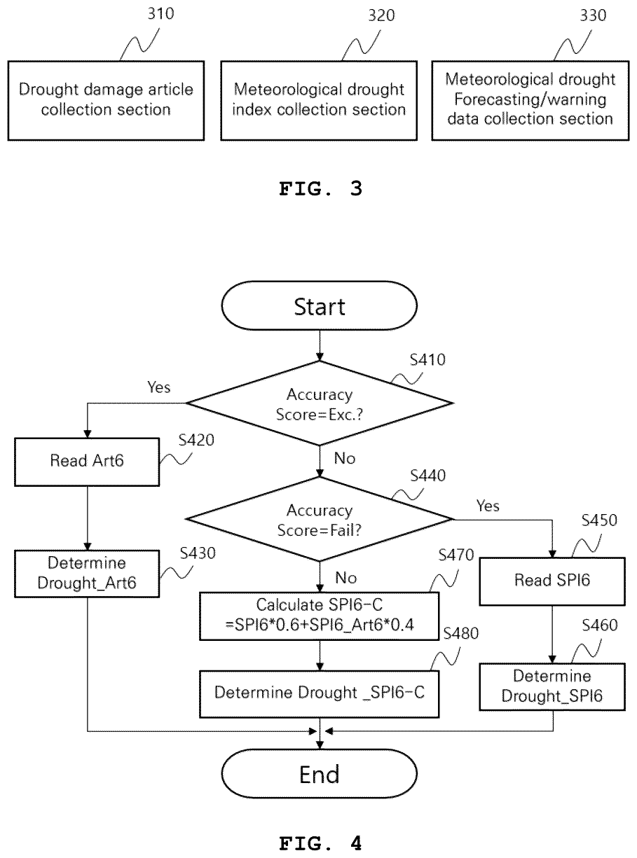

FIG. 1 is a block diagram of a drought impact assessment system based on text mining for drought damage articles and actual data according to an embodiment of the present disclosure, FIG. 2 is a flowchart of a drought impact assessment process according to an embodiment of the present disclosure, FIG. 3 is a detailed configuration diagram of a data collection unit according to an embodiment of the present disclosure, and FIG. 4 is a flowchart of meteorological drought stage assessment according to an embodiment of the present disclosure.

The drought impact assessment system based on text mining for drought damage articles and actual data according to the embodiment of the present disclosure includes a control unit 110, a data collection unit 120, a DB construction unit 130, a meteorological drought impact index assessment unit 140, an accuracy verification unit 150, an accuracy evaluation unit 160, and a meteorological drought stage assessment unit 170.

In detail, the data collection unit 120 includes a drought damage article collection section 310, a meteorological drought index collection section 320, and a meteorological drought forecasting/warning data collection section 330.

The drought damage article collection section 310 collects past drought damage article data in order to construct meteorological damage article occurrence history data by region, for example, by city, county and district. As past drought damage articles, press releases related with drought damage are collected through web crawling performed using “drought” as a search word, and meteorological damage articles are filtered by extracting nouns from text words in the articles.

The meteorological drought index collection section 320 collects standard precipitation index (SPI6) data by region, for example, by city, county and district, from the Korea Meteorological Administration for use in verifying the accuracy of a meteorological drought impact index.

The meteorological drought forecasting/warning data collection section 330 collects meteorological drought forecasting/warning data from the Korea Meteorological Administration for use in verifying the accuracy of a meteorological drought impact index.

The DB construction unit 130 constructs and outputs atypical drought damage data on the basis of the drought damage article data collected by the data collection unit 120. The time unit of the atypical drought damage data is daily, and a meteorological damage article occurrence history database by month/region is constructed on the basis of the atypical drought damage data. The meteorological damage article occurrence history database by month/region (e.g., city, country and district) is automatically produced on a monthly basis, and may be constructed by items such as date and time, region (e.g., city, county and district) name and meteorological damage article occurrence/non-occurrence. In addition, the DB construction unit 130 constructs and outputs a standard precipitation index (SPI6) database by city, county and district on the basis of the standard precipitation index (SPI6) data by city, county and district collected by the meteorological drought index collection section 320. Furthermore, the DB construction unit 130 constructs and outputs a meteorological drought forecasting/warning database on the basis of the meteorological drought forecasting/warning data collected by the meteorological drought forecasting/warning data collection section 330.

The meteorological drought impact index assessment unit 140 assesses a meteorological drought impact index (Art6), which is an index that aggregates the occurrence of monthly drought damage for six months from the present time, using the meteorological damage article occurrence history by month/region outputted from the DB construction unit 130, and outputs the meteorological drought impact index (Art6). The meteorological drought impact index (Art6) is a meteorological drought impact index for a specific region for past six months up to a month t, and is expressed as in Equation 1.

$$Art 6 = ( {\sum }_{Δ t = 0}^{5} A r ( t - Δ t ) ) \div 6 \qquad [ Equation 1 ]$$

Here, Art is a drought impact index that indicates whether a meteorological damage article for a specific region r has occurred in the month t, and has a value of 0 or 1.

Therefore, when no meteorological damage article occurs in a specific region for past six months from a specific month, Art6 is 0, and when a meteorological damage article occurs every month, Art6 is 1.

Drought classification depending on drought impact index and standard precipitation index is as shown in Table 1.

TABLE 1

| Drought | Standard precipitation | |
|---|---|---|
| impact index | index (SPI6) | Drought classification |
| 0 | −0.99~0.99 | Normal |
| 0.16 | −1.00~−1.49 | Near Normal |
| 0.33 | −1.50~−1.99 | Abnormally Dry |
| 0.5 | | Moderately Dry |
| 0.66 | −2.00~−2.50 | Severe Dry |
| 0.83 | | Extreme Dry |
| 1 | −2.50 [symbol] | Super Extreme Dry |

The accuracy verification unit 150 analyzes the linear correlation of Equation 2 between the meteorological drought impact index (Art6) outputted from the meteorological drought impact index assessment unit 140 and the standard precipitation index (SPI6) data by city, county and district outputted from the DB construction unit 130, and outputs a correlation coefficient.

$${r}_{{XY}^{=}} \frac{{\sum }_{i = 1}^{n} ( {X}_{i} - {X}_{mean} ) ( {Y}_{i} - {Y}_{mean} )}{\sqrt{{\sum }_{i = 1}^{n} {( {X}_{i} - {X}_{mean} )}^{2}} \sqrt{{\sum }_{i = 1}^{n} {( {Y}_{i} - {y}_{mean} )}^{2}}} \qquad [ Equation 2 ]$$

Here, Xi is a meteorological drought impact index (Art6), Xmean is the mean of meteorological drought impact indexes (Art6), Yi is a standard precipitation index (SPI6) by city, county and district, Ymean is the mean of standard precipitation indexes (SPI6) by city, county and district, and n is the number of data.

The correlation coefficient calculated through linear correlation analysis has a value between +1 and −1, where +1 means perfect positive linear correlation, 0 means no linear correlation and −1 means perfect negative linear correlation. The correlation coefficient in the range of −1.0 to −0.1 indicates negative correlation, and the correlation coefficient in the range of +0.1 to +1.0 indicates positive correlation.

The accuracy evaluation unit 160 classifies the correlation coefficient outputted from the accuracy verification unit 150 and the meteorological drought forecasting/warning performance into four cases according to the TFPN matrix of Table 2.

In detail, the four cases may be classified into a case where the correlation coefficient is positive or negative and may be classified into a case where drought forecasting/warning occurrence performance is positive or negative.

TABLE 2

| | | Drought forecasting/warning performance | |
|---|---|---|---|
| | | Drought forecasting/ | Drought forecasting/ |
| | | warning occurrence | warning non-occurrence |
| | | Positive | Negative |
| Correlation | Positive | TP (True Positive) | FN (False Negative) |
| coefficient | Negative | FP (False Positive) | TN (True Negative) |

The accuracy evaluation unit 160 assesses a drought index accuracy according to a drought index accuracy assessment equation of Equation 3 for the four cases, and determines the drought index accuracy according to Table 3.

$$Accuracy = \frac{T P + T N}{T P + F P + F N + T N} \qquad [ Equation 3 ]$$

Here, TP is a case where a drought forecasting/warning occurs and the correlation coefficient is positive, FP is a case where a drought forecasting/warning occurs and the correlation coefficient is negative, FN is a case where a drought forecasting/warning does not occur and the correlation coefficient is positive, and TN is a case where a drought forecasting/warning does not occur and the correlation coefficient is negative.

TABLE 3

| Accuracy Score | 1.0~0.9 | 0.9~0.7 | below 0.7 |
|---|---|---|---|
| Evaluation | Excellent | Good | Fail |

That is to say, a drought index is evaluated as excellent when the drought index accuracy is between 0.9 and 1.0, is evaluated as good when the drought index accuracy is between 0.7 and 0.9, and is evaluated as fail when the drought index accuracy is less than 0.7.

The meteorological drought stage assessment unit 170 assesses a drought stage by applying, depending on the drought index accuracy, one of drought classification according to a drought impact index, drought classification according to a standard precipitation index and drought classification according to a value obtained by correcting a standard precipitation index (see FIG. 4).

In detail, a drought stage calculation procedure in the meteorological drought stage assessment unit 170 is explained as follows with reference to FIG. 4.

Whether a drought index accuracy is ‘Excellent’ is determined (S410). When the drought index accuracy is ‘Excellent,’ the drought impact index assessed by the meteorological drought impact index assessment unit 140 is read (S420), and a meteorological drought classification corresponding to the drought impact index is determined as a current drought stage (S430).

On the other hand, when the drought index accuracy is not ‘Excellent,’ whether the drought index accuracy is ‘Fail’ is determined (S440). When the drought index accuracy is ‘Fail,’ a standard precipitation index (SPI6) stored in the DB construction unit 130 is read (S450), and a meteorological drought classification corresponding to the standard precipitation index (SPI6) is determined as a current drought stage (S460).

Finally, when the drought index accuracy is not ‘Fail,’ a corrected standard precipitation index (SPI6-C) is calculated by multiplying the standard precipitation index (SPI6) and a median value SPI6_Art6 of a standard precipitation index range corresponding to a drought impact index (Art6) at a predetermined ratio, for example, 6:4 (S470), and a meteorological drought classification corresponding to the corrected standard precipitation index (SPI6-C) is determined as a current drought stage (S480).

For example, when a drought index accuracy is ‘Excellent’ and a drought impact index is 0.33, a drought stage is assessed as ‘Abnormally Dry.’ When a drought index accuracy is ‘Fail’ and a standard precipitation index (SPI6) is −2.1, a drought stage is assessed as ‘Severe Dry.’ When a drought index accuracy is ‘Good’, a drought impact index (Art6) is 0.33 and a standardized precipitation index (SPI6) is −1.4, the median of the standardized precipitation index (SPI6) corresponding to the drought impact index (Art6) of 0.33 is −1.75, and thus, SPI6-C=−1.4*0.6+(−1.75*0.4)=−1.54. In other words, it may be seen that, when only a standard precipitation index (SPI6) is applied, a drought stage is determined as ‘Near Normal,’ but, when a drought index accuracy is applied according to the present disclosure, a drought stage is adjusted upward to ‘Abnormally Dry.’

While various embodiments have been described above, it will be understood to those skilled in the art that the embodiments described are by way of example only. Accordingly, the disclosure described herein should not be limited based on the described embodiments.

What is claimed is:

1. A drought impact assessment system based on text mining for drought damage articles and actual data, comprising:
a data collection/storage unit configured to construct data by collecting drought damage article data for a predetermined period of time, collecting a standard precipitation index by region from the database of the Korea Meteorological Administration and collecting meteorological drought forecasting/warning data from the database of the Korea Meteorological Administration;
a meteorological drought impact index assessment unit configured to output a meteorological drought impact index that aggregates the occurrence of monthly drought damage for the predetermined period of time, using a meteorological damage article occurrence history by month/region outputted from the data collection/storage unit;
an accuracy verification unit configured to analyze the linear correlation between the meteorological drought impact index outputted from the meteorological drought impact index assessment unit and the standard precipitation index by region, and output a correlation coefficient;
an accuracy evaluation unit configured to classify the correlation coefficient outputted from the accuracy verification unit and meteorological drought forecasting/warning performance into four cases, and calculate a drought index accuracy according to a predetermined drought index accuracy assessment equation for the four cases; and
a meteorological drought stage assessment unit configured to assess a drought stage by applying, depending on the drought index accuracy, one of drought classification according to a drought impact index, drought classification according to a standard precipitation index and drought classification according to a value obtained by correcting a standard precipitation index.

2. The drought impact assessment system according to claim 1, wherein the meteorological drought impact index (Art6) satisfies the following equation
$$Art 6 = ( {\sum }_{Δ t = 0}^{5} A r ( t - Δ t ) ) \div 6$$
where Art is a drought impact index that indicates whether a meteorological damage article for a specific region r has occurred in a month t, and has a value of 0 or 1.

3. The drought impact assessment system according to claim 1, wherein the correlation coefficient (rXY) satisfies the following equation 4
$${r}_{{XY}^{=}} \frac{{\sum }_{i = 1}^{n} ( {X}_{i} - {X}_{mean} ) ( {Y}_{i} - {Y}_{mean} )}{\sqrt{{\sum }_{i = 1}^{n} {( {X}_{i} - {X}_{mean} )}^{2}} \sqrt{{\sum }_{i = 1}^{n} {( {Y}_{i} - {y}_{mean} )}^{2}}}$$
where Xi is a meteorological drought impact index (Art6), Xmean is the mean of meteorological drought impact indexes (Art6), Yi is a standard precipitation index (SPI6) by city, county and district, Ymean is the mean of standard precipitation indexes (SPI6) by city, county and district, and n is the number of data.

4. The drought impact assessment system according to claim 1, wherein the drought index accuracy satisfies the following equation
$$Accuracy = \frac{T P + T N}{T P + F P + F N + T N}$$
where TP is a case where a drought forecasting/warning occurs and a correlation coefficient is positive, FP is a case where a drought forecasting/warning occurs and a correlation coefficient is negative, FN is a case where a drought forecasting/warning does not occur and a correlation coefficient is positive, and TN is a case where a drought forecasting/warning does not occur and a correlation coefficient is negative.

5. The drought impact assessment system according to claim 1, wherein the meteorological drought stage assessment unit performs:
a function of determining whether the drought index accuracy is ‘Excellent,’ reading, when the drought index accuracy is ‘Excellent,’ a drought impact index assessed by the meteorological drought impact index assessment unit, and determining a meteorological drought classification corresponding to the drought impact index as a current drought stage;
a function of determining, when the drought index accuracy is not ‘Excellent,’ whether the drought index accuracy is ‘Fail,’ reading, when the drought index accuracy is ‘Fail,’ a standard precipitation index stored in the data collection/storage unit, and determining a meteorological drought classification corresponding to the standard precipitation index as a current drought stage; and
a function of, when the drought index accuracy is not ‘Excellent’ or ‘Fail,’ calculating a corrected standard precipitation index (SPI6-C) by multiplying the standard precipitation index (SPI6) and a median value (SPI6_Art6) of a standard precipitation index range corresponding to the drought impact index (Art6) at a predetermined ratio, and determining a meteorological drought classification corresponding to the corrected standard precipitation index (SPI6-C) as a current drought stage.

6. A drought impact assessment method based on text mining for drought damage articles and actual data, comprising:
a data collection/storage act of constructing data in a data collection/storage unit by collecting drought damage article data for a predetermined period of time, collecting a standard precipitation index by region from the database of the Korea Meteorological Administration and collecting meteorological drought forecasting/warning data from the database of the Korea Meteorological Administration;
a meteorological drought impact index assessment act of outputting a meteorological drought impact index that aggregates the occurrence of monthly drought damage for the predetermined period of time, using a meteorological damage article occurrence history by month/region outputted from the data collection/storage act;
an accuracy verification act of analyzing the linear correlation between the meteorological drought impact index outputted from the meteorological drought impact index assessment act and the standard precipitation index by region, and outputting a correlation coefficient;
an accuracy evaluation act of classifying the correlation coefficient outputted from the accuracy verification act and meteorological drought forecasting/warning performance into four cases, and calculating a drought index accuracy according to a predetermined drought index accuracy assessment equation for the four cases; and
a meteorological drought stage assessment act of assessing a drought stage by applying, depending on the drought index accuracy, one of drought classification according to a drought impact index, drought classification according to a standard precipitation index and drought classification according to a value obtained by correcting a standard precipitation index.

7. The drought impact assessment method according to claim 6, wherein the meteorological drought stage assessment act comprises:
an act of determining whether the drought index accuracy is ‘Excellent,’ reading, when the drought index accuracy is ‘Excellent,’ a drought impact index assessed in the meteorological drought impact index assessment act, and determining a meteorological drought classification corresponding to the drought impact index as a current drought stage;
an act of determining, when the drought index accuracy is not ‘Excellent,’ whether the drought index accuracy is ‘Fail,’ reading, when the drought index accuracy is ‘Fail,’ a standard precipitation index stored in the data collection/storage unit, and determining a meteorological drought classification corresponding to the standard precipitation index as a current drought stage; and
an act of, when the drought index accuracy is not ‘Excellent’ or ‘Fail,’ calculating a corrected standard precipitation index (SPI6-C) by multiplying the standard precipitation index (SPI6) and a median value (SPI6_Art6) of a standard precipitation index range corresponding to the drought impact index (Art6) at a predetermined ratio, and determining a meteorological drought classification corresponding to the corrected standard precipitation index (SPI6-C) as a current drought stage.
